(19) United States
(12) Patent Application Publication
(10) Pub. No.: US 2025/0153608 A1
(43) Pub. Date: May 15, 2025

(54) ELECTRIFIED VEHICLE AND METHOD OF CONTROLLING BATTERY OUTPUT THEREOF

(71) Applicants: HYUNDAI MOTOR COMPANY, SEOUL (KR); KIA CORPORATION, SEOUL (KR)

(72) Inventor: Do Sung Hwang, Gunpo-si (KR)

(73) Assignees: HYUNDAI MOTOR COMPANY, SEOUL (KR); KIA CORPORATION, SEOUL (KR)

(21) Appl. No.: 18/657,057

(22) Filed: May 7, 2024

(30) Foreign Application Priority Data
Nov. 13, 2023 (KR) 10-2023-0156512

(51) Int. Cl. B60L 58/12

(52) U.S. Cl. CPC B60L 58/12; B60L 2240/547; B60L 2240/549

(57) ABSTRACT

An electrified vehicle and a method of controlling a battery output thereof, includes a battery including a plurality of cells, and a controller controlling an output of the battery based on an allowable output of the battery, and adjusting the allowable output when at least one of a first condition determined based on a continuous discharge amount and a preset first reference discharge amount, and a second condition determined based on a cell voltage deviation and a preset first reference deviation is satisfied.

### CROSS REFERENCE TO RELATED APPLICATIONS

The present application claims priority to Korean Patent Application No. 10-2023-0156512, filed Nov. 13, 2023, the entire contents of which is incorporated herein for all purposes by this reference.

### BACKGROUND

### 1. Technical Field

The present disclosure relates to an electrified vehicle and a method of controlling a battery output thereof, which can alleviate the deterioration of a battery cell.

### 2. Description of the Related Art

Recently, as interest in the environment increases, there is a growing trend of an eco-friendly vehicle equipped with an electric motor as a power source. The eco-friendly vehicle is also called an electrified vehicle, and representative examples thereof include a hybrid electric vehicle (HEV) or an electric vehicle (EV).

Such an electrified vehicle may be provided with a motor to be driven using the driving force of the motor, and the motor may be supplied with power from a battery to be operated. The battery may supply power to the motor by discharging the stored power, and may be composed of a plurality of cells.

Depending on the operation of the battery, deterioration may occur in the battery cell. When the deterioration occurs in the cell, the voltage of the cell may fall below a preset lower limit voltage, potentially affecting drivability causing issues such as acceleration failure.

Therefore, it is necessary to propose a method that can alleviate the deterioration of the cell in order to ensure the drivability of the vehicle running on the power of the battery.

The description provided above as a related art of the present disclosure is for helping understand the background of the present disclosure and should not be construed as being included in the related art known by those skilled in the art.

### SUMMARY

An objective of the present disclosure is to provide an electrified vehicle and a method of controlling a battery output thereof, which limit the continuous discharge of a battery cell to prevent a cell voltage from reaching a lower limit voltage due to cell deterioration.

The objectives of the present disclosure are not limited to the above-mentioned objective, and other objectives which are not mentioned will be clearly understood by those skilled in the art from the following description.

In order to achieve the objective of the present disclosure, there is provided an electrified vehicle, including a controller controlling an output of the battery based on an allowable output of the battery, and adjusting the allowable output when at least one of a first condition determined based on a continuous discharge amount until current of the battery changes from a first state to a second state and a preset first reference discharge amount, and a second condition determined based on a cell voltage deviation between the plurality of cells and a preset first reference deviation is satisfied.

The first condition may be satisfied when the continuous discharge amount exceeds the first reference discharge amount.

The first state may be defined as a state in which the current of the battery is equal to or more than a preset first value (it is 0 or more), and the controller may determine the continuous discharge amount by adding up a discharge amount of the battery in the first state.

The second state may be defined as a state in which the current of the battery is less than a preset second value (it is less than 0), and the controller may initialize the summed continuous discharge amount when the battery current changes from the first state to the second state.

When the current of the battery changes from the first state to a third state in which the battery current is equal to or more than the second value and is less than the first value, the controller may stop adding up the discharge amount and maintain the continuous discharge amount determined by previous summation.

When the first condition is satisfied, the controller may adjust the allowable output downward until the continuous discharge amount reaches a second reference discharge amount that is preset to a value equal to or less than the first reference discharge amount.

When the continuous discharge amount reaches the second reference discharge amount through the downward adjustment, the controller may adjust the allowable output upward to a state before the downward adjustment.

The second condition may be satisfied, when the cell voltage deviation is equal to or more than the first reference deviation.

When the second condition is satisfied, the controller may adjust the allowable output downward until the cell voltage deviation reaches the first reference deviation.

The controller may maintain the lowered allowable output until the cell voltage deviation reaches a second reference deviation that is preset to a value less than the first reference deviation through the downward adjustment.

The controller may adjust the allowable output upward to a state before the downward adjustment, when the cell voltage deviation reaches the second reference deviation through the downward adjustment.

The controller may adjust the allowable output downward when at least one of the first condition and the second condition is satisfied in a state where a State of charge (SOC) of the battery is less than a preset reference SOC.

The controller may output information corresponding to failure of at least one of the plurality of cells, when the second condition is satisfied in a state where the SOC of the battery is equal to or more than the preset reference SOC.

The controller may adjust the allowable output downward when at least one of the first condition, the second condition, and a third condition determined based on a lowest cell voltage that is a lowest voltage among voltages of the plurality of cells and the preset first reference voltage is satisfied.

The third condition may be satisfied when the lowest cell voltage is less than the first reference voltage.

When the third condition is satisfied, the controller may adjust the allowable output downward until the lowest cell voltage reaches the first reference voltage.

The controller may maintain the lowered allowable output until the lowest cell voltage reaches a second reference voltage that is preset to exceed the first reference voltage through the downward adjustment.

The controller may adjust the allowable output upward to a state before the downward adjustment, when the lowest cell voltage reaches the second reference voltage through the downward adjustment.

The controller may output information corresponding to failure of at least one of the plurality of cells, when the third condition is satisfied in a state where the SOC of the battery is equal to or more than the preset reference SOC.

In order to achieve the objective of the present disclosure, there is provided a method of controlling a battery output of an electrified vehicle, the method including controlling the output of a battery based on an allowable output of the battery including a plurality of cells, and adjusting the allowable output when at least one of a first condition determined based on a continuous discharge amount until current of the battery changes from a first state to a second state and a preset first reference discharge amount, and a second condition determined based on a cell voltage deviation between the plurality of cells and a preset first reference deviation is satisfied.

According to various embodiments of the present disclosure, deterioration of a battery can be alleviated and reaching the lower limit voltage of the battery can be suppressed by limiting the continuous discharge of the battery and reducing a voltage deviation between a plurality of cells of the battery.

Thus, battery durability is improved, so the drivability of a vehicle can be secured

Further, when the lower limit voltage of a battery is reached, it is possible to protect the battery by limiting the discharge of the battery.

The effects of the present disclosure are not limited to the above-mentioned effects, and other effects which are not mentioned will be clearly understood by those skilled in the art from the following description.

### BRIEF DESCRIPTION OF THE FIGURES

FIG. 1 is a diagram illustrating the configuration of an electrified vehicle according to an embodiment of the present disclosure.

FIGS. 2A and 2B are diagrams for explaining an output control performed by a controller when a first condition is satisfied, according to an embodiment of the present disclosure.

FIGS. 3A and 3B are diagrams for explaining an output control performed by a controller when a second condition is satisfied, according to an embodiment of the present disclosure.

FIGS. 4A and 4B are diagrams for explaining an output control performed by a controller when a third condition is satisfied, according to an embodiment of the present disclosure.

FIG. 5 is a diagram for explaining an overall output control performed by a controller, according to an embodiment of the present disclosure.

FIG. 6 is a flowchart for explaining a process of controlling a battery output of an electrified vehicle, according to an embodiment of the present disclosure.

### DETAILED DESCRIPTION

Specific structural or functional descriptions in the embodiments of the present disclosure introduced in this specification or application are only for description of the embodiments of the present disclosure. The present disclosure may be embodied in many different forms, and should not be construed as being limited to the embodiments described in the specification or application.

Since various changes and modifications of the embodiments may be made, preferred embodiments will be illustrated in the drawings and described in detail in the specification or application. However, it is to be understood that the present description is not intended to limit the present disclosure to those exemplary embodiments, and the present disclosure is intended to cover not only the exemplary embodiments, but also various alternatives, modifications, equivalents and other embodiments that fall within the spirit and scope of the present disclosure.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

Hereinafter, the exemplary embodiments of the present disclosure will be described in detail with reference to the accompanying drawings. The same reference numerals are used throughout the drawings to designate the same or similar components.

In the description of the following embodiments, the term “preset” means that the numerical value of a parameter is predetermined when using the parameter in a process or algorithm. According to an embodiment, the numerical value of the parameter may be set when the process or algorithm starts or may be set for a period in which the process or algorithm is performed.

The words “module” and “part” for components used in the following description are given or used interchangeably only for the case of preparing the specification, and do not have distinct meanings or roles in themselves.

In the following description, if it is decided that the detailed description of known technologies related to the present disclosure makes the subject matter of the embodiments described herein unclear, the detailed description is omitted. Further, the accompanying drawings are provided only for easy understanding of embodiments disclosed in the specification, and the technical spirit disclosed in the specification is not limited by the accompanying drawings, and all changes, equivalents, and replacements should be understood as being included in the spirit and scope of the present disclosure.

It will be understood that, although the terms “first”, “second”, etc. may be used herein to describe various components, these components should not be limited by these terms. These terms are only used to distinguish one component from another component.

It will be understood that when a component is referred to as being “coupled” or “connected” to another component, it can be directly coupled or connected to the other component or intervening components may be present therebetween. In contrast, it should be understood that when a component is referred to as being “directly coupled” or “directly connected” to another component, there are no intervening components present.

In the present disclosure, the singular forms are intended to include the plural forms as well, unless the context clearly indicates otherwise.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In addition, a unit or control unit included in names such as a motor control unit (MCU) and a hybrid control unit (HCU) is only the term that is widely used to name a controller for controlling a specific function of a vehicle, and does not mean a generic function unit.

A controller may include a communication device that communicates with other controllers or sensors to control an assigned function, a memory that stores an operating system, logic instructions, input/output information or the like, and one or more processors that perform judgments, operations, and decisions required to control an assigned function.

An electrified vehicle and a method of controlling a battery output thereof according to an embodiment of the present disclosure are proposed to alleviate the continuous discharge of a battery, the expansion of a voltage deviation between cells, and the reaching of a lower limit voltage by adjusting the allowable output of the battery. This suppresses battery deterioration, thereby improving battery durability, and preventing drivability from being impaired due to the battery deterioration.

Hereinafter, before describing the method of controlling the battery output according to an embodiment of the present disclosure, the configuration of the electrified vehicle according to an embodiment of the present disclosure will be first described.

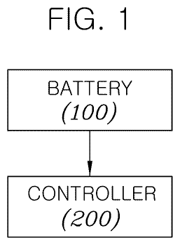

FIG. 1 is a diagram illustrating the configuration of an electrified vehicle according to an embodiment of the present disclosure.

Referring to FIG. 1, the electrified vehicle according to an embodiment of the present disclosure may include a battery 100 and a controller 200. However, FIG. 1 mainly shows components related to the description of an embodiment. Of course, the electrified vehicle may be actually implemented to include more or fewer components.

First, the battery 100 is composed of a plurality of cells, and the state of the battery 100 may be expressed as voltage, current, temperature, State of Charge (SOC), etc. In particular, the plurality of cells may have different voltages depending on respective deterioration states, and a voltage difference between the cells may be expressed as a cell voltage deviation.

The controller 200 may obtain or determine the state of the battery 100, such as current, voltage, temperature, or SOC, and the output of the battery 100 may be controlled based on the obtained or determined state of the battery 100. To this end, the controller 200 may be implemented to include a Battery Management System (BMS), a Vehicle Control Unit (VCU) and the like, or may be implemented separately from the BMS and VCU to perform cooperative control with the BMS and VCU.

To be more specific, the controller 200 may control the output of the battery 100 based on the allowable output of the battery 100, and may adjust the allowable output when at least one of a first condition and a second condition for the battery 100 is satisfied.

Here, the allowable output is an upper limit at which the battery 100 is allowed to be discharged, and is distinguished from a maximum output that may be actually output by the battery 100. For example, when the allowable output is higher than the maximum output, the controller 200 may control the battery 100 to be discharged at the maximum output. In contrast, when the maximum output is lower than the allowable output, the battery 100 may be controlled to be discharged within the allowable output.

The allowable output may vary depending on the state of the battery 100, and may be adjusted to protect the battery 100. In an embodiment of the present disclosure, the controller 200 may adjust the allowable output based on the first condition related to the continuous discharge of the battery and the second condition related to the cell voltage deviation.

In particular, when at least one of the first condition and the second condition is satisfied, the controller 200 may limit the discharge of the battery 100 by downwardly adjusting the allowable output.

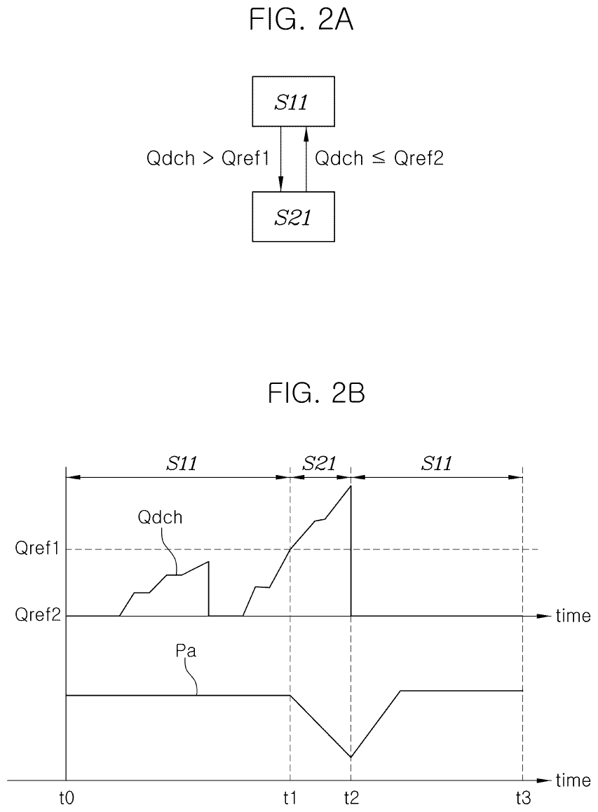

To be more specific, the first condition may be determined to be satisfied based on a continuous discharge amount until the current of the battery 100 changes from a first state to a second state and a preset first reference discharge amount. This will be described with reference to FIGS. 2A and 2B.

FIGS. 2A and 2B are diagrams for explaining the output control performed by the controller when the first condition is satisfied, according to an embodiment of the present disclosure.

To be more specific, FIG. 2A shows a control state transition process of the allowable output, and FIG. 2B shows a change process of the continuous discharge amount as the allowable output is adjusted.

Referring to FIGS. 2A and 2B, the controller 200 may determine whether the first condition is satisfied based on the continuous discharge amount Qdch until the current of the battery 100 changes from the first state to the second state and the preset first reference discharge amount Qref1.

Here, the first state may be defined as a state in which the current of the battery 100 is equal to or more than a preset first value (it is 0 or more). For example, the first value may be 0.0 A. The second state may be defined as a state in which the current of the battery 100 is less than a preset second value (it is less than 0). For example, the second value may be −30.0 A. According to an embodiment, the first state may mean a discharge state in which the current of the battery 100 has a positive value, and the second state may mean a charge state in which the current of the battery 100 has a negative value.

The controller 200 may determine the continuous discharge amount Qdch by adding up the discharge amount of the battery 100 in the first state. When the battery 100 continues to be discharged, the continuous discharge amount Qdch may increase over time.

However, the controller 200 may initialize the summed continuous discharge amount Qdch when the battery changes from the first state to the second state. In this case, the currently determined continuous discharge amount Qdch may have the value of ‘0 A·s’. That is, since the continuous discharge amount Qdch is a measure for determining the continuous discharge of the battery 100, it is initialized when the battery 100 stops discharging. This may be distinguished from a cumulative discharge amount that corresponds to the sum of the total discharge amount.

When the current of the battery 100 changes from the first state to a third state in which the battery current is equal to or more than the second value and is less than the first value, the controller 200 may stop adding up the discharge amount and maintain the value of the continuous discharge amount Qdch determined by previous summation.

For example, the third state may be defined as a state in which the current of the battery 100 is −30.0 A or more and less than 0 A depending on the settings of the first value and the second value. In the third state, the battery 100 may stop discharging and perform charging. However, in order to prevent the sum of the continuous discharge amount Qdch from being initialized during temporary discharge interruption and charging, the controller 200 may stop adding up the discharge amount and maintain the continuous discharge amount Qdch, instead of initializing the continuous discharge amount Qdch in the third state. Thereby, it is possible to more precisely reflect the continuous discharge state of the battery 100 in the control and effectively alleviate the deterioration of the battery 100.

The controller 200 may determine whether the first condition is satisfied based on the continuous discharge amount Qdch determined in this way and the preset first reference discharge amount Qref1. For example, when the continuous discharge amount Qdch exceeds the first reference discharge amount Qref1, the controller may determine that the first condition is satisfied. That is, the first condition is a condition for limiting the continuous discharge of the battery 100. When the battery 100 is continuously discharged beyond a certain level, the controller 200 may adjust the allowable output downward, thus suppressing the discharge of the battery 100.

To be more specific, when the first condition is satisfied, the controller 200 may adjust the allowable output Pa downward until the continuous discharge amount Qdch reaches a preset second reference discharge amount Qref2. In this case, the second reference discharge amount Qref2 may be set to a value smaller than the first reference discharge amount Qref1, and may be set to the same value as the first reference discharge amount Qref1.

Subsequently, when the continuous discharge amount Qdch reaches the second reference discharge amount Qref through the downward adjustment, the controller 200 may adjust the allowable output Pa upward to a state before the downward adjustment.

For example, referring to the graph of FIG. 2B, between t0 and t1, the continuous discharge amount Qdch of the battery 100 is equal to or less than the first reference discharge amount Qref1. In this case, the controller 200 may operate in a mode S11 in which the allowable output Pa is not adjusted downward, considering that it is unnecessary to limit the continuous discharge.

Between t1 and t2, the battery 100 is in a state in which the continuous discharge amount Qdch has a value between the first reference discharge amount Qref1 and the second reference discharge amount Qref2. If the continuous discharge amount Qdch exceeds the first reference discharge amount Qref1 after time t1 when the continuous discharge amount Qdch reaches the first reference discharge amount Qref1, the controller 200 may operate in a mode S21 in which the allowable output Pa is adjusted downward until the continuous discharge amount Qdch reaches the second reference discharge amount Qref2. In this case, the allowable output Pa may be lowered, for example, to 0 kW.

Between t2 and t3, as the allowable output Pa is adjusted downward, the battery 100 is in a state in which the continuous discharge amount Qdch is equal to or less than the first reference discharge amount Qref1. As the satisfaction state of the first condition is released, the controller 200 may operate in a mode S11 in which the allowable output Pa is not adjusted downward. In this case, the controller 200 may adjust the allowable output Pa upward again to a state before the downward adjustment. Since the allowable output Pa serves as the upper limit of the output of the battery 100, the actual output of the battery 100 may not match the allowable output Pa.

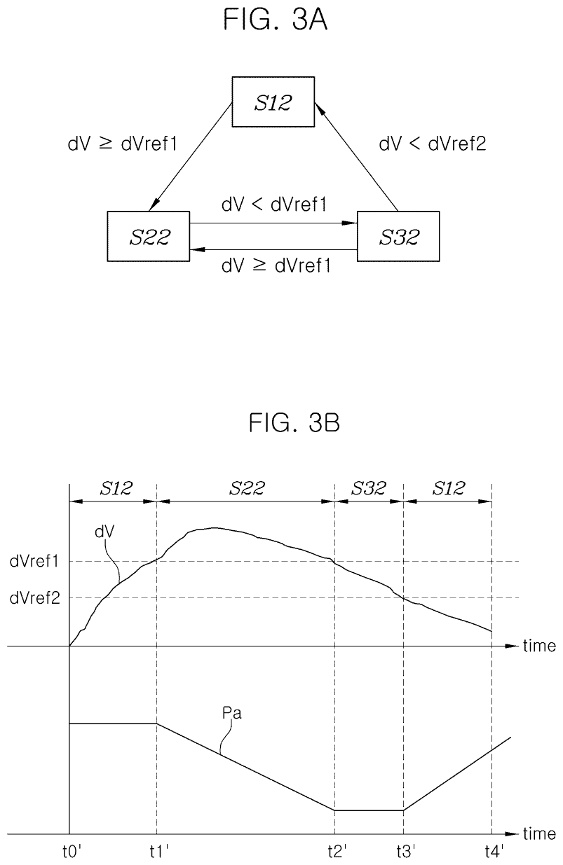

Meanwhile, the second condition may be determined based on the cell voltage deviation between a cell with a highest voltage and a cell with a lowest cell voltage among the plurality of cells and a preset first reference deviation. This will be described with reference to FIGS. 3A and 3B.

FIGS. 3A and 3B are diagrams for explaining the output control performed by the controller when the second condition is satisfied, according to an embodiment of the present disclosure.

Referring to FIGS. 3A and 3B, the controller 200 may determine whether the second condition is satisfied based on a cell voltage deviation dV between the plurality of cells of the battery 100 and a preset first reference deviation dVref1.

Here, the cell voltage deviation dV may especially mean the cell voltage deviation between the cell with the highest voltage and the cell with the lowest cell voltage among the plurality of cells. When the deterioration of a particular cell progresses relatively more than that of the other cells in the plurality of cells, the cell voltage deviation may further increase.

The controller 200 may determine whether the second condition is satisfied based on the cell voltage deviation dV and the preset first reference deviation dVref1. For example, when the cell voltage deviation dV exceeds the first reference deviation dVref1, the controller may determine that the second condition is satisfied. That is, the second condition is a condition for limiting the expansion of the cell voltage deviation of the battery 100. When the cell voltage deviation dV of the battery 100 is expanded beyond a certain level, the controller 200 may adjust the allowable output Pa downward, thus suppressing the discharge of the battery 100.

To be more specific, when the second condition is satisfied, the controller 200 may adjust the allowable output Pa downward until the cell voltage deviation dV reaches the preset first reference deviation dVref1.

After the cell voltage deviation dV reaches the preset first reference deviation dVref1, the controller 200 may maintain the lowered allowable output Pa until the cell voltage deviation dV reaches the preset second reference deviation dVref2 instead of completing the lowering of the allowable output Pa. That is, when the second condition is satisfied and the allowable output Pa is adjusted downward, the controller 200 may control to maintain the allowable output Pa in the downwardly adjusted state for a certain period rather than immediately restoring the allowable output Pa even if the satisfaction of the second condition is released.

Thereafter, when the cell voltage deviation dV reaches the second reference deviation dVref2 according to the lowered allowable output Pa, the controller 200 may adjust the allowable output Pa upward to a state before the downward adjustment.

For example, referring to the graph of FIG. 3B, between t0′ and t1′, the cell voltage deviation dV of the battery 100 is equal to or less than the first reference deviation dVref1. In this case, the controller 200 may operate in a mode S12 in which the allowable output Pa is not adjusted downward, considering that it is unnecessary to limit the expansion of the cell voltage deviation.

Between t1′ and t2′, the battery 100 is in a state in which the cell voltage deviation dV exceeds the first reference deviation dVref1. If the cell voltage deviation dV exceeds the first reference deviation dVref1 after time t1′ when the cell voltage deviation dV reaches the first reference deviation dVref1, the second condition is satisfied. Thus, the controller 200 may operate in a mode S22 in which the allowable output Pa is adjusted downward until the cell voltage deviation dV reaches the first reference deviation dVref1.

Between t2′ and t3′, as the allowable output Pa is adjusted downward, the battery 100 is in a state in which the cell voltage deviation dV is less than the first reference deviation dVref1 and more than the second reference deviation dVref2, and the controller 200 may operate in a mode S32 that maintains the allowable output Pa in a lowered state in this period.

Between t3′ and t4′, the cell voltage deviation dV is less than the second reference deviation dVref2. When the allowable output Pa is adjusted downward and maintained and the cell voltage deviation dV reaches the second reference deviation dVref2, the controller 200 may operate in a mode S12 in which the allowable output Pa is not adjusted downward. In this case, the controller 200 may adjust the allowable output Pa upward to a state before the downward adjustment.

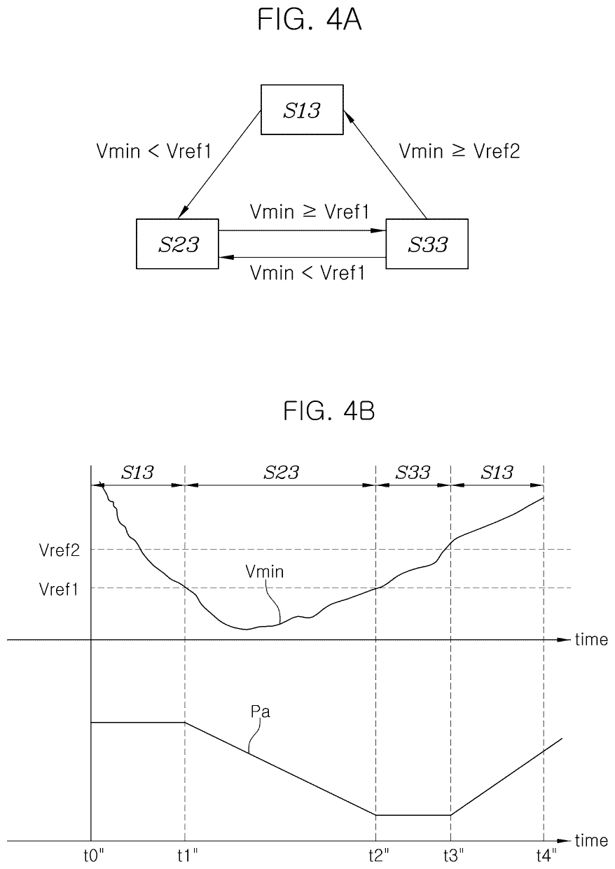

Meanwhile, the controller 200 may adjust the allowable output by considering whether the third condition related to reaching the lower limit voltage of the battery 100 is satisfied, in addition to the above-described first condition and second condition. When any one of the first condition, the second condition, and the third condition is satisfied, the allowable output may be adjusted downward. This will be described with reference to FIGS. 4A and 4B.

FIGS. 4A and 4B are diagrams for explaining the output control performed by the controller when the third condition is satisfied, according to an embodiment of the present disclosure.

Referring to FIGS. 4A and 4B, the controller 200 may determine whether the third condition is satisfied based on the cell voltage of the battery 100 and a preset first reference voltage Vref1. In particular, the cell voltage may mean the lowest value among the plurality of cell voltages, that is, a lowest cell voltage Vmin.

The controller 200 may determine whether the third condition is satisfied based on the lowest cell voltage Vmin and the preset first reference voltage Vref1. For example, when the lowest cell voltage Vmin is less than the first reference voltage Vref1, it may be determined that the third condition is satisfied. That is, the third condition is a condition for limiting the cell voltage of the battery 100 from reaching the lower limit voltage. The first reference voltage Vref1 may correspond to the lower limit voltage. When the lowest cell voltage Vmin of the battery 100 falls below the lower limit voltage, the controller 200 may adjust the allowable output Pa downward, thus suppressing the discharge of the battery 100.

To be more specific, when the third condition is satisfied, the controller 200 may adjust the allowable output Pa downward until the lowest cell voltage Vmin reaches the preset first reference voltage Vref1.

After the lowest cell voltage Vmin reaches the preset first reference voltage Vref1, the controller 200 may maintain the lowered allowable output Pa until the lowest cell voltage Vmin reaches a preset second reference voltage Vref2 instead of completing the lowering of the allowable output Pa. That is, when the third condition is satisfied and the allowable output Pa is adjusted downward, the controller 200 may control to maintain the allowable output Pa in the downwardly adjusted state for a certain period rather than immediately restoring the allowable output Pa even if the satisfaction of the third condition is released.

Thereafter, when the lowest cell voltage Vmin reaches the second reference voltage Vref2 according to the lowered allowable output Pa, the controller 200 may adjust the allowable output Pa upward to a state before the downward adjustment.

For example, referring to the graph of FIG. 4B, between t0″ and t1″, the battery 100 is in a state in which the lowest cell voltage Vmin exceeds the first reference voltage Vref1. In this case, the controller 200 may operate in a mode S13 in which the allowable output Pa is not adjusted downward, considering that it is unnecessary to limit the reaching of the lower limit voltage.

Between t1″ and t2″, the battery 100 is in a state in which the lowest cell voltage Vmin is less than the first reference voltage Vref1. If the lowest cell voltage Vmin is less than the first reference voltage Vref1 after time t1″ when the lowest cell voltage Vmin reaches the first reference voltage Vref1, the controller 200 may operate in a mode S23 in which the allowable output Pa is adjusted downward until the lowest cell voltage Vmin reaches the first reference voltage Vref1.

Between t2″ and t3″, as the allowable output Pa is adjusted downward, the battery 100 is in a state in which the lowest cell voltage Vmin is between the first reference voltage Vref1 and the second reference voltage Vref2, and the controller 200 may operate in a mode S33 that maintains the allowable output Pa in a lowered state in this period.

Between t3″ and t4″, the lowest cell voltage Vmin exceeds the second reference voltage Vref2. When the allowable output Pa is adjusted downward and maintained and the lowest cell voltage Vmin reaches the second reference voltage Vref2, the controller 200 may operate in a mode S13 in which the allowable output Pa is not adjusted downward. In this case, the controller 200 may adjust the allowable output Pa upward to a state before the downward adjustment.

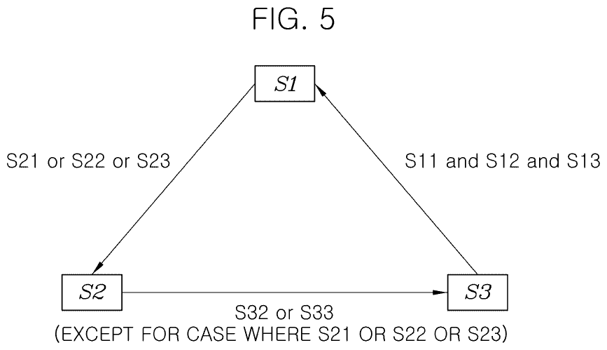

FIG. 5 is a diagram for explaining an overall output control performed by the controller, according to an embodiment of the present disclosure.

Referring to FIG. 5, control logic for determining the final allowable output of the battery 100 according to the operation mode of the controller 200 described in FIGS. 2A to 4B is shown.

When all of the first condition, the second condition, and the third condition are not satisfied and the allowable output is not adjusted downward (S11 and S12 and S13), the controller 200 operates in a mode S1 that controls the output of the battery 100 based on the allowable output that is not lowered.

While operating in the mode S1, if any one of the first condition, the second condition, and the third condition is satisfied and the allowable output is adjusted downward (S21 or S22 or S23), the controller 200 operates in a mode S2 that adjusts the allowable output downward and controls the output of the battery 100.

While operating in the mode S2, if at least one of the second condition and the third condition is satisfied and the lowered allowable output is maintained (S32 or S33), the controller 200 operates in a mode S3 that controls the output of the battery 100 based on the lowered allowable output. However, when at least one of the first condition, the second condition, and the third condition is satisfied and the allowable output is adjusted downward (S21 or S22 or S23), the controller operates in the mode S2 that adjusts the allowable output downward and controls the output of the battery 100.

On the other hand, when at least one of the first condition and the second condition is satisfied in a state where the SOC of the battery 100 is less than a preset reference SOC, the controller 200 may adjust the allowable output downward. In the case where the SOC of the battery 100 is equal to or more than the reference SOC, the controller may not adjust the allowable output even when the first condition and the second condition are satisfied. Further, in the case where the SOC of the battery 100 is equal to or more than the reference SOC, the controller 200 may not adjust the allowable output even when the third condition is satisfied.

However, when the second condition or the third condition is satisfied in a state where the SOC of the battery 100 is equal to or more than the reference SOC, the controller 200 may diagnose that the battery 100 is malfunctioning, and may output information corresponding to the failure of at least one of the plurality of cells.

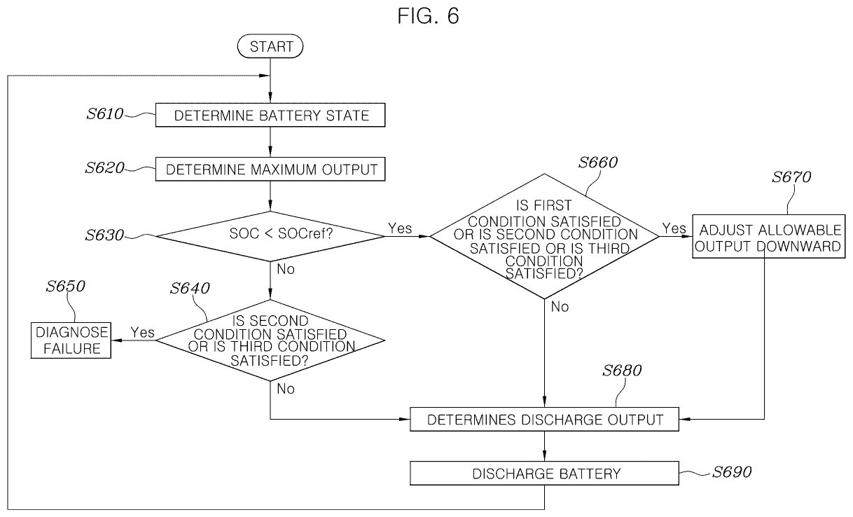

FIG. 6 is a flowchart for explaining a process of controlling a battery output of an electrified vehicle, according to an embodiment of the present disclosure.

Referring to FIG. 6, first, the controller 200 may determine the battery state, which is an input variable of an operation for controlling the output of the battery 100 (S610). In this case, the battery state may include the current and temperature of the battery 100, the highest voltage, lowest cell voltage, SOC of the cell included in the battery 100, etc.

Before determining the output of the battery 100, the controller 200 may determine the maximum output of the battery 100. For example, the maximum output may be determined based on the SOC and temperature of the battery 100. To this end, a previously or set output map may be utilized (S620).

Subsequently, the controller 200 compares the SOC of the battery 100 and a reference SOC SOCref (S630). In the case where the SOC of the battery 100 is equal to or more than the reference SOC SOCref (No in S630), the allowable output may not be adjusted downward even when the first condition, second condition, and third condition are satisfied. However, when the second condition is satisfied or the third condition is satisfied in this case (No in S630), the controller 200 may diagnose a failure by determining that the failure has occurred in the cell of the battery 100 itself, and may output information corresponding thereto (S650).

On the other hand, when the SOC of the battery 100 is less than the reference SOC SOCref (No in S630), the controller 200 adjusts the allowable output downward if at least one of the first condition, second condition and third condition is satisfied (Yes in S660) (S670).

After the above processes are performed, the controller 200 determines the final discharge output of the battery 100 based on the allowable output (S680), and the battery 100 performs the discharge according to a final discharge output command of the controller 200.

As described above, according to various embodiments of the present disclosure, deterioration of a battery can be alleviated and reaching the lower limit voltage of the battery can be suppressed by limiting the continuous discharge of the battery and reducing a voltage deviation between a plurality of cells of the battery.

Thus, battery durability is improved, so the drivability of a vehicle can be secured

Further, when the lower limit voltage of a battery is reached, it is possible to protect the battery by limiting the discharge of the battery.

Although the present disclosure was provided above in relation to specific embodiments shown in the drawings, it is apparent to those skilled in the art that the present disclosure may be changed and modified in various ways without departing from the scope of the present disclosure, which is described in the following claims.

1. An electrified vehicle, comprising:
a battery including a plurality of cells; and
a controller controlling an output of the battery based on an allowable output of the battery, and adjusting the allowable output when at least one of: (i) a first condition determined based on a continuous discharge amount until current of the battery changes from a first state to a second state and a preset first reference discharge amount, and (ii) a second condition determined based on a cell voltage deviation between the plurality of cells and a preset first reference deviation is satisfied.

2. The electrified vehicle of claim 1, wherein the first condition is satisfied when the continuous discharge amount exceeds the first reference discharge amount.

3. The electrified vehicle of claim 1, wherein the first state is defined as a state in which the current of the battery is equal to or more than a preset first value, and
the controller determines the continuous discharge amount by adding up a discharge amount of the battery in the first state.

4. The electrified vehicle of claim 3, wherein the second state is defined as a state in which the current of the battery is less than a preset second value, and
the controller initializes a summed continuous discharge amount when the battery current changes from the first state to the second state.

5. The electrified vehicle of claim 4, wherein, when the current of the battery changes from the first state to a third state in which the battery current is equal to or more than the second value and is less than the first value, the controller stops adding up the discharge amount and maintains the continuous discharge amount determined by previous summation.

6. The electrified vehicle of claim 2, wherein, when the first condition is satisfied, the controller adjusts the allowable output downward until the continuous discharge amount reaches a second reference discharge amount that is preset to a value equal to or less than the first reference discharge amount.

7. The electrified vehicle of claim 6, wherein, when the continuous discharge amount reaches the second reference discharge amount through the downward adjustment, the controller adjusts the allowable output upward to a state before the downward adjustment.

8. The electrified vehicle of claim 1, wherein the second condition is satisfied, when the cell voltage deviation is equal to or more than the first reference deviation.

9. The electrified vehicle of claim 8, wherein, when the second condition is satisfied, the controller adjusts the allowable output downward until the cell voltage deviation reaches the first reference deviation.

10. The electrified vehicle of claim 9, wherein the controller maintains a lowered allowable output until the cell voltage deviation reaches a second reference deviation that is preset to a value less than the first reference deviation through the downward adjustment.

11. The electrified vehicle of claim 10, wherein the controller adjusts the allowable output upward to a state before the downward adjustment, when the cell voltage deviation reaches the second reference deviation through the downward adjustment.

12. The electrified vehicle of claim 1, wherein the controller adjusts the allowable output downward when at least one of the first condition and the second condition is satisfied in a state where a State of charge (SOC) of the battery is less than a preset reference SOC.

13. The electrified vehicle of claim 12, wherein the controller outputs information corresponding to failure of at least one of the plurality of cells, when the second condition is satisfied in a state where the SOC of the battery is equal to or more than the preset reference SOC.

14. The electrified vehicle of claim 1, wherein the controller adjusts the allowable output downward when at least one of the first condition, the second condition, and a third condition determined based on a lowest cell voltage that is a lowest voltage among voltages of the plurality of cells and a preset first reference voltage is satisfied.

15. The electrified vehicle of claim 14, wherein the third condition is satisfied when the lowest cell voltage is less than the first reference voltage.

16. The electrified vehicle of claim 15, wherein, when the third condition is satisfied, the controller adjusts the allowable output downward until the lowest cell voltage reaches the preset first reference voltage.

17. The electrified vehicle of claim 16, wherein the controller maintains a lowered allowable output until the lowest cell voltage reaches a second reference voltage that is preset to exceed the first reference voltage through the downward adjustment.

18. The electrified vehicle of claim 17, wherein the controller adjusts the allowable output upward to a state before the downward adjustment, when the lowest cell voltage reaches the second reference voltage through the downward adjustment.

19. The electrified vehicle of claim 14, wherein the controller outputs information corresponding to failure of at least one of the plurality of cells, when the third condition is satisfied in a state where a SOC of the battery is equal to or more than a preset reference SOC.

20. A method of controlling a battery output of an electrified vehicle, the method comprising:
controlling the output of a battery based on an allowable output of the battery including a plurality of cells; and
adjusting the allowable output when at least one of a first condition determined based on a continuous discharge amount until current of the battery changes from a first state to a second state and a preset first reference discharge amount, and a second condition determined based on a cell voltage deviation between the plurality of cells and a preset first reference deviation is satisfied.
